(19) United States
(12) Patent Application Publication
(10) Pub. No.: US 2026/0249477 A1
(43) Pub. Date: Aug. 27, 2026

(54) SYSTEMS AND METHODS FOR MULTI-OBJECT ROBOTIC GRASPING

(71) Applicant: UNIVERSITY OF SOUTH FLORIDA, Tampa, FL (US)

(72) Inventors: Tianze CHEN, Tampa, FL (US); Yu SUN, Tampa, FL (US)

(21) Appl. No.: 19/551,521

(22) Filed: Feb. 26, 2026

Related U.S. Application Data
(60) Provisional application No. 63/763,538, filed on Feb. 26, 2025.

(51) Int. Cl. B25J 9/16

(52) U.S. Cl. CPC B25J 9/1697; G05B 2219/39001

(57) ABSTRACT

Examples of the present disclosure provide a system, a process, and a non-transitory computer readable medium for controlling a robotic arm. In some examples, a system includes a memory storing instructions and at least one processor electronically coupled with the memory, the robotic arm, and an image sensor. The at least one processor is operable to execute the instructions to cause the system to detect, based on image data received from the image sensor, a plurality of objects; identify a plurality of candidate pairs of objects from the plurality of objects; identify a respective grasping pose for each respective candidate pair based on a respective orientation of the respective candidate pair; select a selected pair of objects from the plurality of candidate pairs and a selected grasping pose for the selected pair based on grasping confidence; and execute a grasping action based on the selected grasping pose to grasp the selected pair of objects.

### CROSS-REFERENCE TO RELATED APPLICATIONS

This Application claims priority to U.S. Provisional Patent Application No. 63/763,538, filed on Feb. 26, 2025, entitled “Multi-Object Grasping-Grasping from Surface of Pile,” the entire disclosure of which is incorporated herein by reference.

### BACKGROUND

Robotic manipulation systems may be tasked with picking a specified number of objects from an unorganized group or pile, such as from a bin, container, or conveyor. Selectively picking multiple objects in a single grasping action, for example, grasping two objects simultaneously, may improve throughput and efficiency in such applications.

Some robotic grasping systems may employ mechanisms such as scoops or similar devices that do not provide the dexterity required for selective multi-object picking. Other systems may be configured to detect and pick objects arranged on a flat, uniform surface. In practice, objects may instead be arranged in piles or bins in which each object may have a different depth and orientation relative to adjacent objects, presenting challenges for systems designed for flat-surface scenarios.

These challenges may be further compounded when the objects to be grasped are non-spherical, such as cuboids, which do not yield or roll aside when contacted by a robotic end effector. Grasping such objects from a pile in a controlled manner, specifying the number of objects to be grasped in a single action, may require identifying and targeting specific spatial gaps and approach trajectories, rather than relying on blind insertion or bulk-pickup methods.

### SUMMARY

One example provides a system for a robotic arm. The system includes a memory storing instructions, and at least one processor electronically coupled with the memory, the robotic arm, and an image sensor. The at least one processor is operable to execute the instructions to cause the system to: detect, based on image data received from the image sensor, a plurality of objects; identify a plurality of candidate pairs of objects from the plurality of objects; identify a respective grasping pose for each respective candidate pair based on a respective orientation of the respective candidate pair; select a selected pair of objects from the plurality of candidate pairs and a selected grasping pose for the selected pair based on grasping confidence; and execute a grasping action based on the selected grasping pose to grasp the selected pair of objects.

In some aspects, the techniques described herein relate to a system wherein the plurality of candidate pairs are identified based on detected positions of the objects without repositioning any object prior to identifying the candidate pairs.

In some aspects, the techniques described herein relate to a system wherein the plurality of objects form a top layer of an object pile, and wherein the two objects of a candidate pair may be at different heights relative to one another within the pile.

In some aspects, the techniques described herein relate to a system wherein, to detect the plurality of objects, the instructions cause the system to: perform object segmentation to separate background content of the image data from the plurality of objects; and determine a spatial configuration of each object of the plurality of objects.

In some aspects, the techniques described herein relate to a system wherein each spatial configuration is a 6-dimensional (6D) estimation having three pose dimensions and three rotation dimensions.

In some aspects, the techniques described herein relate to a system wherein, to identify the plurality of candidate pairs, the instructions cause the system to: determine Euclidean distances between neighboring objects of the plurality of objects and amounts of surrounding free space detected around neighboring objects of the plurality of objects.

In some aspects, the techniques described herein relate to a system wherein candidate pairs having a Euclidean distance above a first threshold are discarded as candidates, and candidate pairs having an amount of surrounding free space below a second threshold are discarded as candidates.

In some aspects, the techniques described herein relate to a system wherein, to identify a respective grasping pose, the instructions cause the system to: select a contact surface for an object in the respective candidate pair based on an unobstructed volume between the contact surface and an adjacent object; and determine a finger insertion location relative to the respective candidate pair based on the contact surface.

In some aspects, the techniques described herein relate to a system wherein, to identify a respective grasping pose, the instructions cause the system to: compute a respective surface normal for each object in the respective candidate pair; compute a respective angle between the respective surface normal and a surrounding environment z-axis; identify a top surface and a bottom surface of each respective object in the respective candidate pair based on the respective angle; and select the contact surface from a surface different from the top surface and the bottom surface of each respective object in the respective candidate pair.

In some aspects, the techniques described herein relate to a system wherein the instructions further cause the system to: select an approach angle and orientation for reaching the selected grasping pose based on the grasping confidence; and control a movement of the robotic arm to the selected grasping pose via the approach angle and orientation.

In some aspects, the techniques described herein relate to a system wherein the grasping confidence is determined by a grasp confidence estimator comprising a trained machine learning model calibrated to an end effector of the robotic arm.

In some aspects, the techniques described herein relate to a system wherein the instructions further cause the system to: determine whether a viable candidate pair exists among the plurality of candidate pairs; and in response to determining that no viable candidate pair exists, select a single object from the plurality of objects and execute a single-object grasping action to grasp the selected single object.

In some aspects, the techniques described herein relate to a process for controlling a robotic arm. The process includes, at a processor operably coupled to the robotic arm and an image sensor: detecting, based on image data received from the image sensor, a plurality of objects arranged in a pile; identifying a plurality of candidate pairs of objects from the plurality of objects; for each respective candidate pair, identifying a respective grasping pose for an end effector of the robotic arm to grasp the respective candidate pair based on a respective orientation of the respective candidate pair; selecting a selected pair of objects from the plurality of candidate pairs and a selected grasping pose for the selected pair based on grasping confidence; executing a grasping action with the end effector based on the selected grasping pose to grasp the selected pair of objects; and controlling a movement of the end effector to a destination location.

In some aspects, the techniques described herein relate to a process wherein detecting the plurality of objects includes: performing object segmentation on the image data to separate background content of the image data from the plurality of objects; and determining a spatial configuration of each object of the plurality of objects.

In some aspects, the techniques described herein relate to a process wherein each spatial configuration is a 6-dimensional (6D) estimation having three pose dimensions and three rotation dimensions.

In some aspects, the techniques described herein relate to a process wherein identifying the plurality of candidate pairs includes: determining Euclidean distances between neighboring objects of the plurality of objects and amounts of surrounding free space detected around neighboring objects of the plurality of objects.

In some aspects, the techniques described herein relate to a process wherein candidate pairs having a Euclidean distance above a first threshold are discarded as candidates, and candidate pairs having an amount of surrounding free space below a second threshold are discarded as candidates.

In some aspects, the techniques described herein relate to a process wherein identifying a respective grasping pose includes: selecting a contact surface for an object in the pair of the objects based on an unobstructed volume between the contact surface and an adjacent object; and determining a finger insertion location relative to the respective candidate pair based on the contact surface.

In some aspects, the techniques described herein relate to a process wherein identifying a respective grasping pose further includes: computing a respective surface normal for each object in the candidate pair; computing a respective angle between the respective surface normal and a surrounding environment z-axis; identifying a top surface and a bottom surface of each respective object in the candidate pair based on the respective angle; and selecting the contact surface from a surface different from the top surface and the bottom surface of each respective object in the candidate pair.

In some aspects, the techniques described herein relate to a non-transitory computer readable medium storing instructions that, when executed by a processor, cause the processor to: detect, based on image data received from an image sensor, a plurality of objects; identify a plurality of candidate pairs of objects from the plurality of objects; identify a respective grasping pose for each respective candidate pair based on a respective orientation of the respective candidate pair; select a selected pair of objects from the plurality of candidate pairs and a selected grasping pose for the selected pair based on grasping confidence; and control a robotic arm to execute a grasping action based on the selected grasping pose to grasp the selected pair of objects.

In some aspects, the techniques described herein relate to a non-transitory computer readable medium wherein, to identify the plurality of candidate pairs, the instructions cause the processor to: determine Euclidean distances between neighboring objects of the plurality of objects and amounts of surrounding free space detected around neighboring objects of the plurality of objects.

In some aspects, the techniques described herein relate to a non-transitory computer readable medium wherein candidate pairs having a Euclidean distance above a first threshold are discarded as candidates, and candidate pairs having an amount of surrounding free space below a second threshold are discarded as candidates.

In some examples, a technical challenge in robotic manipulation is the reliable grasping of multiple non-spherical objects simultaneously from a cluttered, non-uniform surface, a task that may involve identifying specific spatial gaps between objects, selecting stable contact surfaces, and planning a collision-free approach trajectory, all in real time based on sensor data. In some examples, the techniques described herein address this challenge through a multi-stage pipeline implemented as computer-executable instructions that cause a processor to: estimate the six-dimensional pose of each detected object; identify candidate object pairs based on their spatial proximity and the available unobstructed volume surrounding each pair; select contact surfaces and finger insertion locations to enable a stable simultaneous grasp; fit candidate grasping poses to the identified pairs; and select among the candidate poses based on a computed grasp confidence. In this manner, the computer programming of the robotic system—rather than mechanical chance or bulk-pickup mechanisms—drives the identification of viable grasping configurations and the selection of the highest-confidence grasp for execution. Among the technical advantages of certain examples of the disclosed techniques is that the system can achieve higher success rates and availability for grasping multiple objects simultaneously from cluttered, non-uniform surfaces. Among the further technical advantages of certain examples of the disclosed techniques is that the robotic system can flexibly adapt its grasping strategy to prioritize feasible grasps, thereby reducing failure rates and optimizing throughput. The foregoing advantages and others are non-limiting examples of the technical improvements enabled by certain examples of the disclosed techniques.

Other aspects will become apparent by consideration of the detailed description and accompanying drawings.

### BRIEF DESCRIPTION OF THE DRAWINGS

FIG. 1 is an example robotic system for picking objects according to the present teachings.

FIG. 2 is a block diagram of the robotic device that may be implemented in conjunction with the robotic device of FIG. 1, according to the present teachings.

FIG. 3 illustrates an example workflow for multi-object grasping, according to the present teachings.

FIG. 4 illustrates an example workflow for performing object detection and segmentation of objects in a pile, according to the present teachings.

FIG. 5 illustrates an example workflow for performing pose estimation of individual detected and segmented objects, according to the present teachings.

FIG. 6 illustrates an example workflow for performing selection of object pairs based on connection distances, according to the present teachings.

FIG. 7 illustrates an example workflow for performing free space computation and contact surface selection for object pairs, according to the present teachings.

FIGS. 8A-8E illustrate example grasping poses for grasping a pair of objects using the end effector, according to the present teachings.

FIG. 9 illustrates a fitting of candidate grasping poses to a model or image of the object pile, according to the present teachings.

FIG. 10 illustrates an example workflow for determining grasp confidence associated with candidate grasping poses, according to the present teachings.

FIG. 11 illustrates an example process for performing multi-object grasping, according to the present teachings.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing details that are pertinent to understanding the examples of the present disclosure so as not to obscure the disclosure with details that will be readily apparent to those of ordinary skill in the art having the benefit of the description herein.

### DETAILED DESCRIPTION

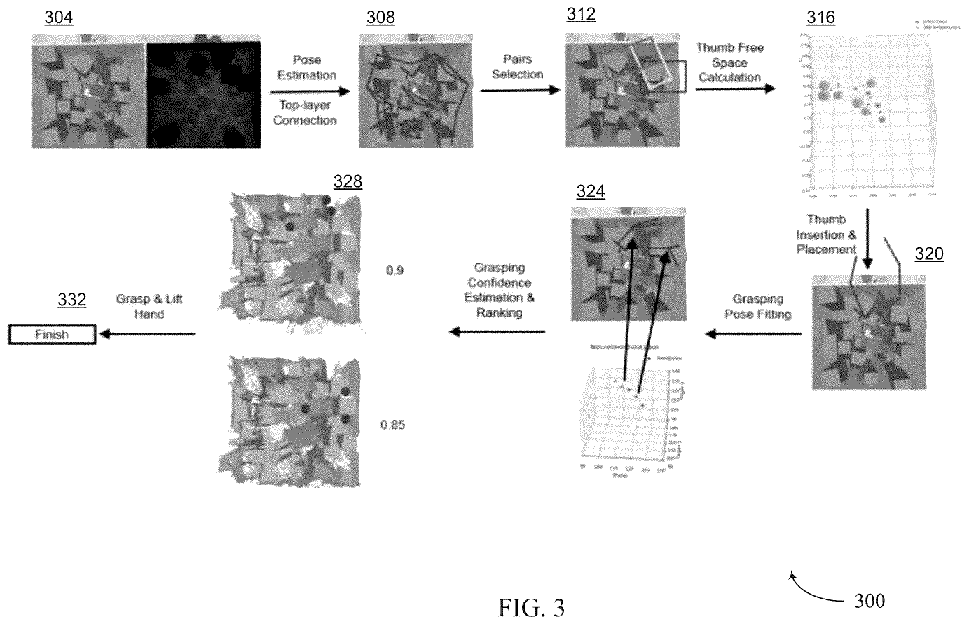

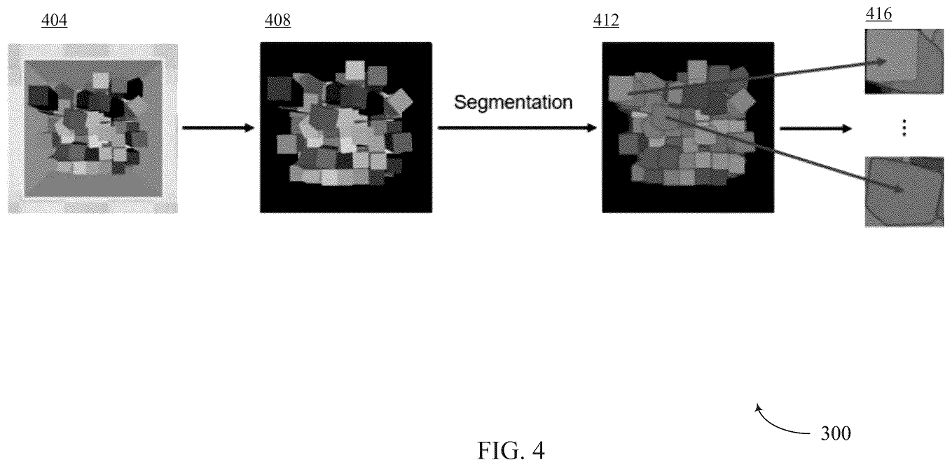

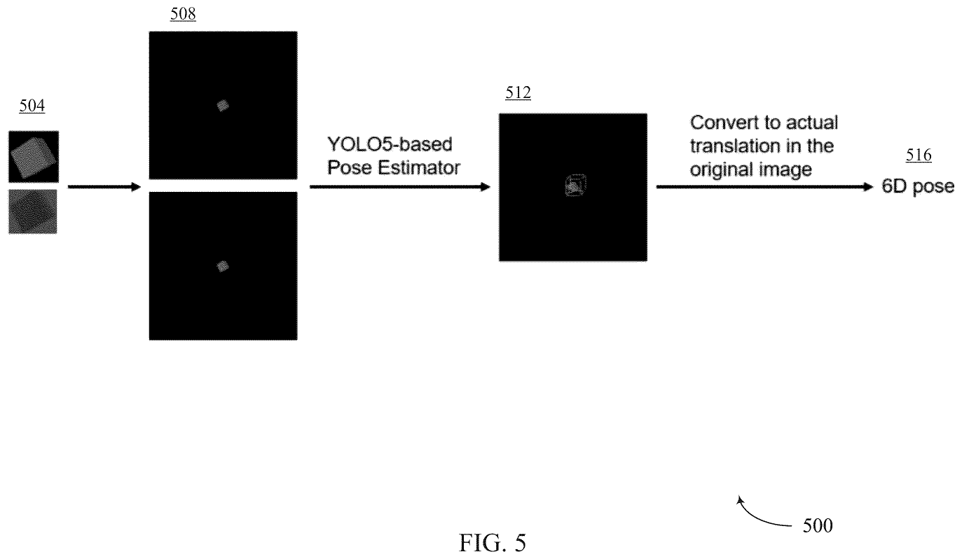

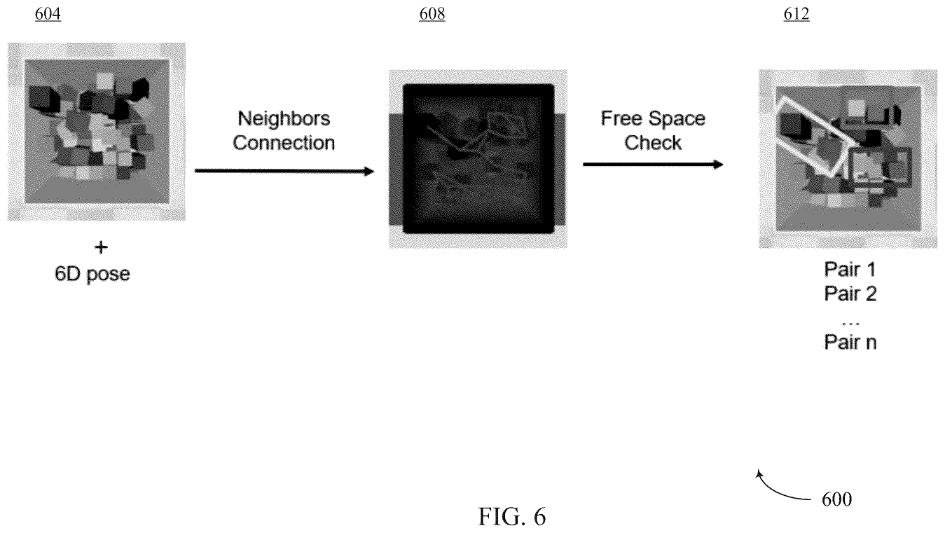

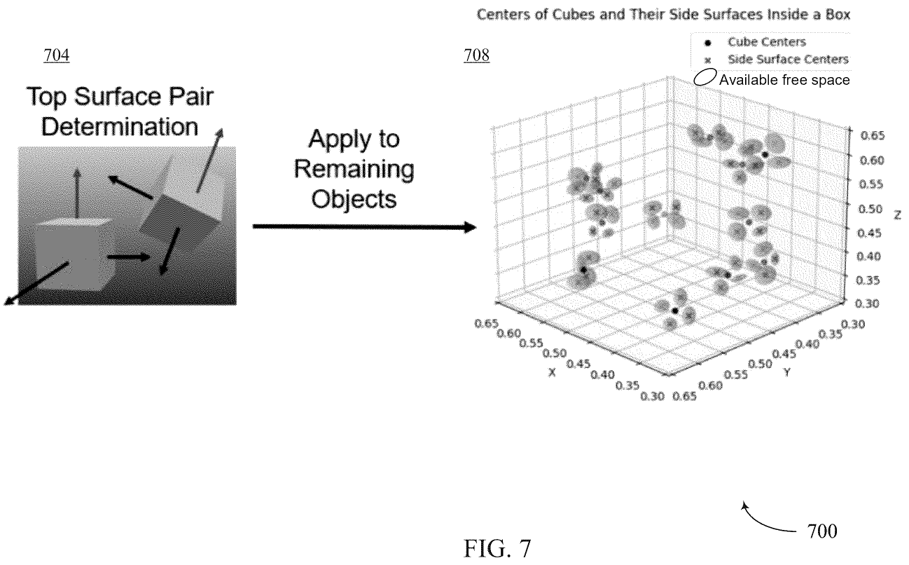

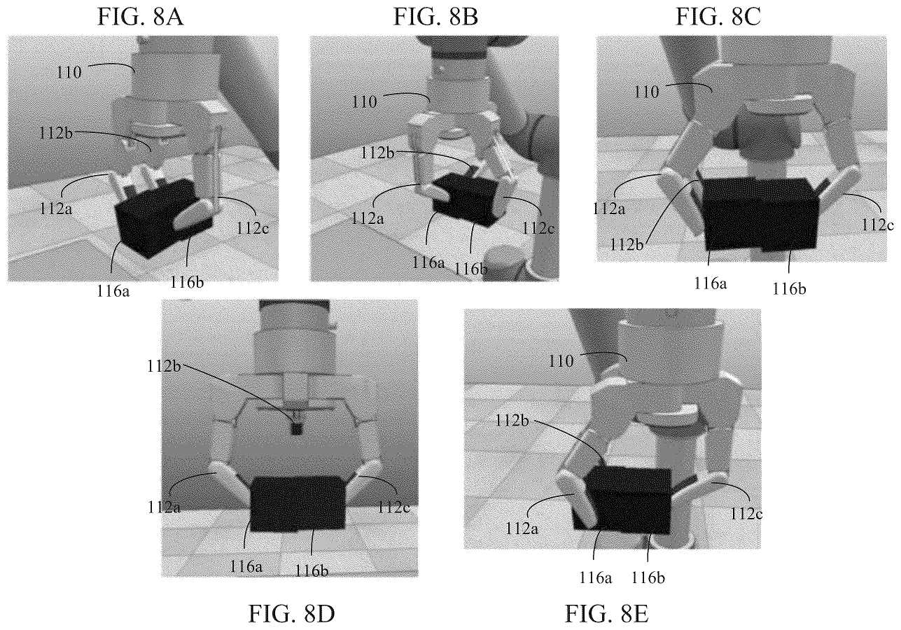

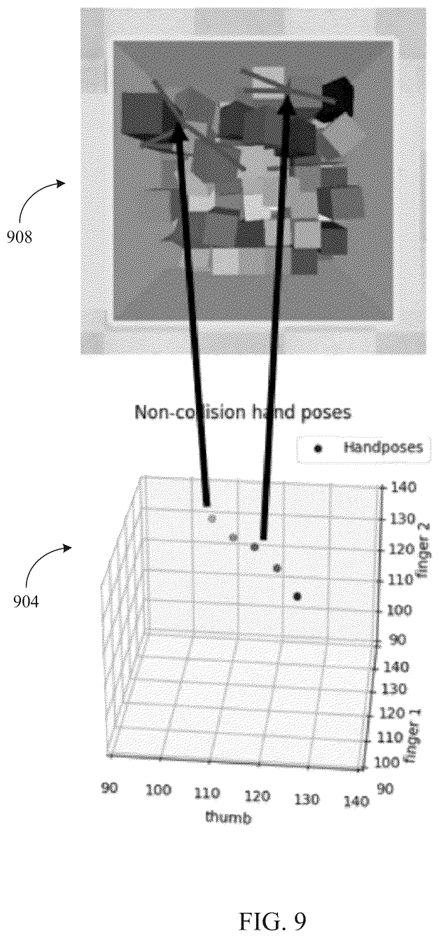

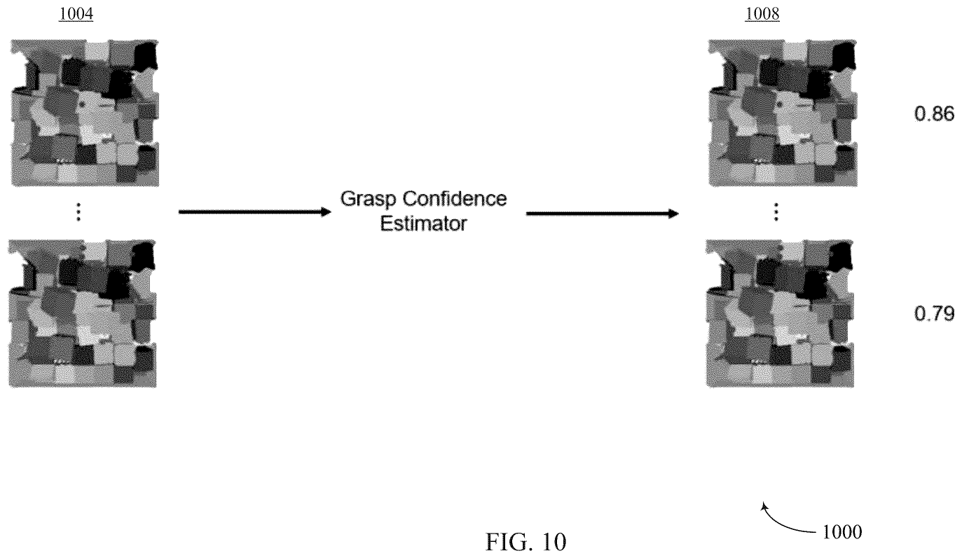

Examples described herein may relate to a vision-based multi-object grasping (MOG) pipeline designed to enhance robotic manipulation in cluttered environments, focusing on the precise and reliable grasping of two objects from a pile. The pipeline stages, illustrated at a high level in the workflow 300 of FIG. 3, may include pose estimation, collision-free object pair identification, finger insertion and placement, grasping pose fitting, and grasp confidence estimation. Image data of objects can be segmented and oriented using 6D pose estimation (as further described with respect to FIGS. 4 and 5), followed by collision-free pair selection based on spatial feasibility and available free space (as further described with respect to FIGS. 6 and 7). Strategic finger placement, including as a specific example thumb placement, may enable grasp stability (as further described with respect to FIGS. 7 and 8A-8E). Iterative refinement of grasping poses enhances adaptability to dynamic configurations (as further described with respect to FIG. 9). Grasp confidence can be assessed to prioritize high-probability configurations for execution (as further described with respect to FIG. 10).

Experimental results have demonstrated robustness and flexibility of the pipeline, achieving at least an 86% success rate in simulations without vision detection and at least 82% with vision, alongside a 100% availability rate when the grasp confidence model prioritizes feasible grasps (including through the single-object fallback described herein). Real-world testing validates the practicality of the pipeline, achieving a 76% success rate with enhanced adaptability. These quantitative results reflect concrete technical improvements in robotic grasping performance produced by the specific multi-stage pipeline architecture disclosed herein. By addressing challenges in robotic manipulation, this MOG pipeline offers a balanced approach between success rate and precision, establishing utility for industrial and research applications.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a special-purpose computer, or other programmable data processing apparatus to produce a special-purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence shown and likewise various blocks may be performed in parallel rather than in sequence.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer-implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

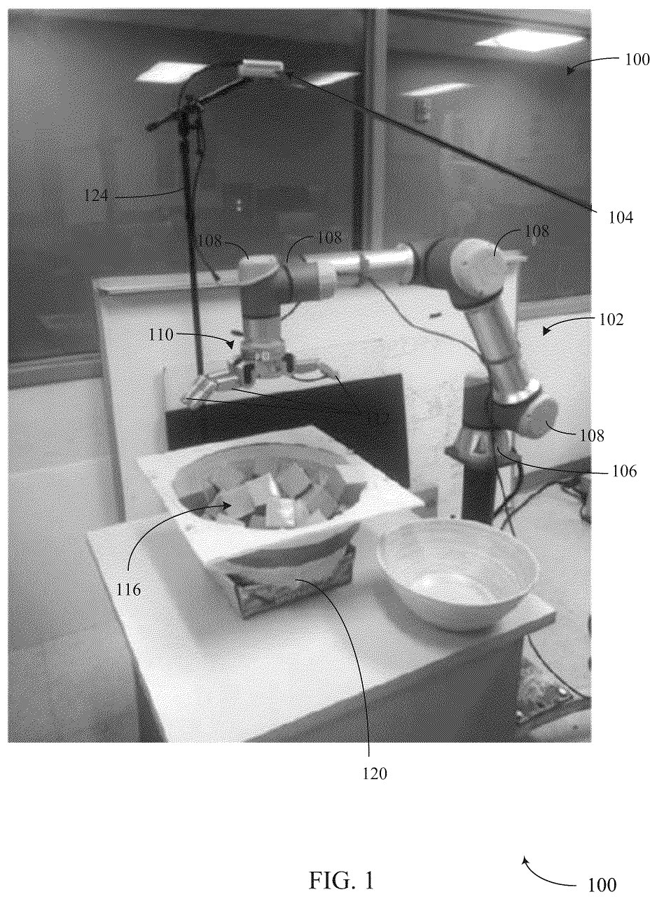

In general terms, and without limitation to the specific examples and figures described herein, aspects of the present disclosure relate to a system, process, and computer readable medium in which a robotic arm is controlled by processor-executed instructions to grasp a pair of objects simultaneously. In some aspects, the processor-executed instructions cause the system to detect a plurality of objects using image data from an image sensor and to identify, from among those objects, candidate pairs based on the objects' spatial proximity to one another and the available unobstructed space surrounding each pair. In some aspects, to identify a grasping pose for a candidate pair, the processor-executed instructions select from a set of candidate grasping poses—each candidate pose representing a possible configuration of the end effector including its position, orientation, and finger arrangement relative to the objects, a subset of poses that are geometrically feasible for the specific candidate pair based on the pair's orientation, the spatial configuration of each object in the pair, the selected contact surfaces, and the unobstructed volume available for finger insertion. In some aspects, a grasp confidence is computed for each feasible candidate pose and the pose with the highest computed grasp confidence is selected for execution. In this manner, the processor-executable instructions, rather than mechanical chance or bulk-pickup mechanisms, drive the selection of a stable, collision-free grasping configuration from a broad space of possible poses, and control the robotic arm to execute the selected grasping action. The specific implementations described herein with respect to FIGS. 1-11 are non-limiting examples of one way to implement the claimed system, process, and computer readable medium.

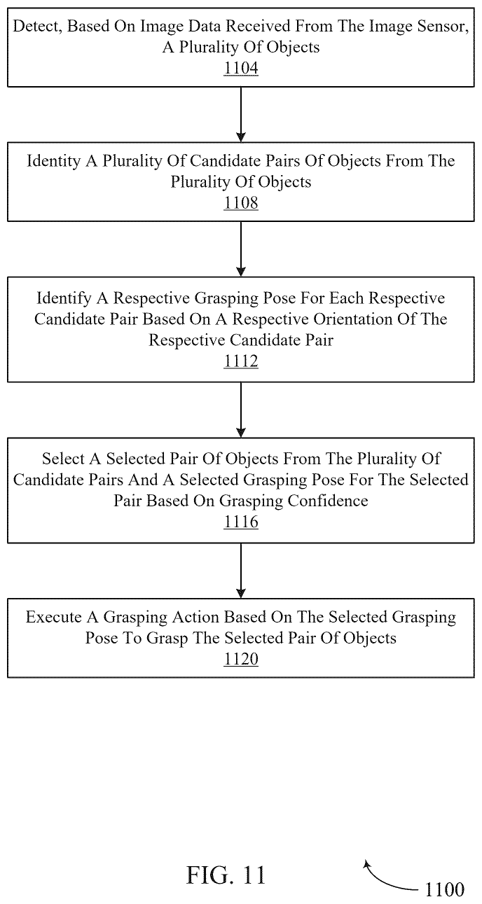

FIG. 1 is an example robotic system 100 for picking objects according to the present teachings. The robotic system 100 may include a robotic device 102, an image sensor 104 (or input to receive sensor data), and a base 106. Moreover, the robotic system 100 may further comprise a memory in communication with a processor, which may be housed within the base 106 and/or other component of the robotic device 102. The processor may be configured to execute instructions embodied in the memory to perform one or more steps of a process, such as the multi-object grasping process described herein with respect to FIGS. 3 and 11.

In some examples, the robotic device 102 may comprise a multi-axis robotic arm with one or more motors 108 to control movement in each axis. The robotic device 102 may further comprise an end effector 110 (also referred to herein as a grasping effector 110), which may include grasping fingers 112. The end effector 110 may be any robotic grasping device capable of grasping two objects 116 simultaneously, including multi-finger robotic hands, two-finger parallel grippers configured for two-object grasping, compliant or rigid grasping mechanisms, and other suitable grasping devices. In some examples, the end effector 110 is a multi-finger robotic hand, such as a Barrett hand or similar device. The fingers 112 may be jointed fingers designed to grasp one or more objects 116 in an environment, as shown in FIG. 1. In the example of FIG. 1, the end effector 110 includes three fingers 112. However, in other examples, the end effector 110 includes more than three fingers 112. In some examples, the end effector 110 includes two fingers 112. In some examples, a selected finger 112 is designated as a thumb for grasping purposes, such that the thumb exerts an opposite and/or perpendicular force relative to other fingers 112 during a grasp. Each configuration of the end effector 110, including its position, orientation, and finger arrangement relative to a target object pair, is referred to herein as a grasping pose. Where the end effector 110 is a robotic hand, the grasping pose may also be referred to as a hand pose, which is one specific example of a grasping pose within the scope of this disclosure. In some examples, the robotic device 102 includes one or more additional sensors to sense movement and/or grasping of objects 116, such as force sensors, accelerometers, position sensors, and/or the like.

The objects 116 may be arranged in a pile in a pick bin 120 or other surface, as depicted in FIG. 1. In that regard, the objects 116 are disposed on a non-uniform surface relative to one another such that the objects 116 have varied orientations and positions in the pick bin 120. Each of the objects 116 may have a known non-spherical shape. In some examples, each of the objects 116 has a shape presenting at least two opposing flat or substantially flat surfaces, such that when two objects 116 are positioned adjacent to one another in the pile, the opposing surfaces of the pair can press against each other and be engaged by the end effector 110 to achieve a stable simultaneous grasp. Suitable shapes include, without limitation, cuboids (e.g., rectangular prisms and/or cubes), rectangular pyramids, and other polyhedral or prismatic forms having at least two opposing surfaces.

The image sensor 104 may be any of a variety of possible image sensor types, such as an optical camera, 3D depth sensor, laser/LiDAR sensor, or the like. In some examples, the image sensor 104 can be a Red Green Blue Depth (RGBD) vision sensor. The type of image sensor 104 may be selected based on the required depth resolution for the pose estimation pipeline, for example, sensors providing depth data (such as RGBD or LiDAR sensors) may improve 6D pose estimation accuracy, while optical cameras may be suitable for implementations using RGB-based pose estimation models. The image sensor 104 may be attached to a stand 124 connected to the base 106, as shown in FIG. 1, or otherwise affixed in a location that provides optimal viewing of the workspace, such as above the pick bin 120. In other examples, the image sensor 104 may be attached to the robotic device 102 itself, such as proximate to the end effector 110. In other examples, the image sensor 104 can be positioned above or to the side of the environment.

As will be described in greater detail below with respect to FIG. 3, the robotic system 100 may be configured to control the motors 108 and the end effector 110 to locate and grasp pairs of the objects 116. In that regard, the processor 202 of the robotic device 102 may select a pair of objects 116 to grasp, and may select a grasping pose for the end effector 110 in order to grasp the objects 116. The grasping pose may have a target location relative to the selected pair of objects 116, a target finger insertion location for at least one finger 112, and a target end effector orientation. The processor 202 may also determine an approach angle and approach orientation for reaching the grasping pose, for example, in a manner that does not disturb the positions of the objects 116 in the pick bin 120 prior to execution of the grasp.

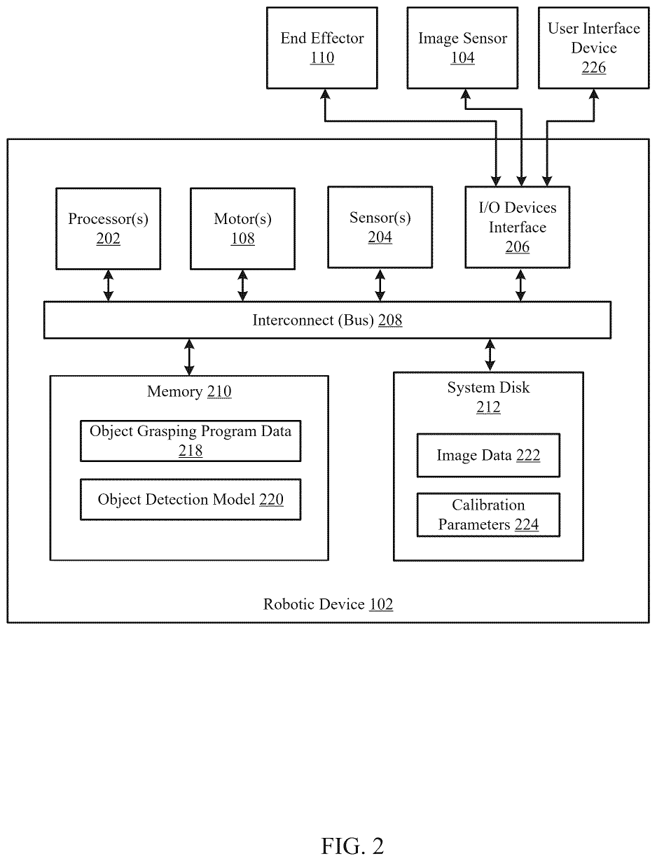

FIG. 2 is a block diagram of the robotic device 102 that may be implemented in conjunction with the robotic system 100 of FIG. 1, according to the present teachings. As shown in FIG. 2, the robotic device 102 can include, without limitation, a processor 202 (e.g., at least one processor 202), the motors 108, sensors 204 (e.g., force sensors, position sensors, movement sensors, etc.), an input/output (I/O) device interface 206, an interconnect 208, a memory subsystem 210, and a system disk 212. The interconnect, or bus, 208 can include one or more wires, cables, traces, contacts, analog components, digital components, wireless connection components, and/or other suitable means for interconnecting hardware components of the robotic device 102.

The processor 202 is adapted to retrieve and execute programming instructions, such as an object grasping program 218 and/or an object detection model 220, stored in the memory 210. Similarly, the processor 202 is adapted to store and access related application data, such as image data 222 captured by the image sensor 104 and/or calibration parameters 224 stored in the system disk 212, as shown in FIG. 2. The interconnect 208 is adapted to facilitate transmission of data, such as programming instructions and application data, between the processor 202, the I/O devices interface 206, the memory 210, and the system disk 212. The I/O devices interface 206 is adapted to receive input data from I/O devices, such as the end effector 110, the image sensor 104, and one or more user interface devices 226, and transmit the input data to the processor 202 via the interconnect 208. For example, user interface devices 226 may include one or more buttons, a keyboard, a mouse, display, and/or other input devices having a wired and/or wireless connection to the I/O devices interface 206. The I/O devices interface 206 is further adapted to receive output data from the processor 202 via the interconnect 208 and transmit the output data to the I/O devices.

The memory 210 includes software instructions for running the object grasping program 218 described herein. The processor 202 can implement the object grasping program 218 to receive sensor data from the image sensor 104 and/or sensors 204, and perform multi-object grasping based on the received sensor data, as described with respect to FIGS. 3-11. In some examples, sensor data received from the sensors 204 and/or the image sensor 104 is pre-processed, for example, using the object detection model 220 invoked by the object grasping program 218. In some examples, the object detection model 220 includes a YOLO model (e.g., YOLOv5 or a later version thereof) or another suitable object detection and segmentation model, which may be used to detect and segment objects 116 in the image data 222. In some examples, the object detection model 220 further includes or is supplemented by a suitable pose estimation model capable of unified object detection and pose estimation, such as a YOLO-based pose model or another suitable pose estimation model.

FIG. 3 illustrates an example workflow 300 for multi-object grasping, according to the present teachings. The workflow 300 may be performed using the components described above with respect to FIGS. 1 and 2. For example, the processor 202 may execute the object grasping program 218 to perform one or more operations of the workflow 300 in conjunction with other components of the robotic system 100, such as the image sensor 104, motors 108, end effector 110, and/or the like. The workflow 300 provides a high-level overview of the multi-stage grasping pipeline, with each stage described in further detail with respect to FIGS. 4-10.

At 304 of the workflow 300, an image of an object pile (e.g., a pile of objects 116 in the pick bin 120 of FIG. 1) is captured using the image sensor 104, and object segmentation is performed on the image. A detailed workflow for performing object segmentation is described with respect to FIG. 4. Object segmentation can include processing the captured image data 222 to separate the objects 116 from the background, and to separate the objects 116 from one another. The objects 116 detected and segmented in the image data 222 may be objects on the surface of the pile in the pick bin 120. In that regard, undetected objects 116 may exist beneath detected objects in the pile. Similarly, some detected objects 116 may be partially obscured by overlapping objects. Object segmentation can include processing using computer vision techniques to recognize object boundaries and distinguish overlapping or partially obscured objects 116 from one another. In some examples, the object segmentation is performed using a Segment Anything model (SAM), a Mask Region-Based Convolutional Neural Network (Mask R-CNN), a transformer-based segmentation model, a point cloud segmentation model suitable for use with 3D depth sensor data, or another instance segmentation model. The particular segmentation model used may be selected based on the type of image sensor 104 employed and the computational resources available. The segmented objects 116 may be individually cropped for pose estimation.

At 308 of the workflow 300, pose estimation of the individual objects 116 is performed to determine the position and orientation of each detected object 116 in three-dimensional (3D) space. A detailed workflow for performing pose estimation is described with respect to FIG. 5. In some examples, the pose estimation is a 6-dimensional (6D) pose estimation having six degrees of freedom (e.g., three degrees of freedom for position and three degrees of freedom for rotation), representing a spatial configuration of the object 116 that describes its position and orientation in 3D space. In this manner, the object grasping program 218 can form a comprehensive model of each object's spatial configuration to plan a safe and accurate grasp. In some examples, pose estimation can be performed using a YOLO-based pose estimation model or another suitable unified detection-and-pose model, a convolutional neural network (CNN)-based 6D pose estimator, a transformer-based pose estimation model, or a point cloud-based estimation method. In examples where the image sensor 104 provides depth data (e.g., an RGBD or LiDAR sensor), the pose estimation may leverage the depth channel to improve estimation accuracy.

Because the objects 116 are arranged in a pile in the pick bin 120 rather than on a flat uniform surface, objects 116 within the same candidate pair may be at different heights (e.g., different positions along the z-axis) relative to one another, as depicted in FIG. 1. For example, one object 116 in a candidate pair may rest on top of an adjacent object 116 or may be partially elevated relative to its pair partner depending on the pile configuration. The 6D pose estimation described above, and further illustrated in FIG. 5, captures the three-dimensional position of each object 116, including its depth or elevation, enabling the system to account for such intra-pair height differences when identifying candidate pairs and their associated grasping poses.

At 312 of the workflow 300, selection of object pairs as candidates is performed. A detailed workflow for performing pairs selection is described with respect to FIG. 6. Based at least in part on the 6D pose estimation of the individual objects 116 described above with respect to step 308 and FIG. 5, connections between neighboring objects 116 on the surface of the pile are determined. The candidate pairs are identified based on the existing detected positions of the objects 116 in the pile, without repositioning or otherwise physically rearranging any object 116 prior to identifying the candidate pairs. In this manner, the system exploits naturally occurring spatial proximity between objects 116 as a basis for pair selection, rather than actively arranging objects 116 to create graspable configurations. In some examples, candidate pairs of objects 116 are determined based on the Euclidean distance between neighboring objects 116 to link each object 116 with a neighbor that is within grasping range of the end effector 110. In some examples, pairs having a Euclidean distance above a first threshold corresponding to the grasping range of the end effector 110 are discarded as candidates, where the first threshold may be stored as part of the calibration parameters 224 associated with the end effector 110 (see FIG. 2). In other examples, other distance metrics may be used to measure the proximity of neighboring objects 116, such as the minimum separation distance between objects' bounding volumes. In that regard, calibration parameters 224 associated with the grasp range of the end effector 110 may be stored in the memory 210 or system disk 212 of the robotic device 102 (see FIG. 2) to perform pairs selection.

A collision check may be performed on each of the candidate pairs identified in step 312 and FIG. 6 to discard any candidate pairs that are not viable or not ideal for multi-object grasping. In that regard, the collision check may include evaluating whether each object 116 in a connection (e.g., in a candidate pair) has sufficient free space around the pair for insertion of the end effector fingers 112 (see FIGS. 1 and 8A-8E). If an object 116 in the candidate pair lacks sufficient free space on one side of the connection, that connection is removed from consideration. The collision check may be iteratively repeated until only collision-free connections remain. In this manner, the object grasping program 218 can generate a final set of connections that are both spatially feasible and collision-free. In some examples, the Euclidean distance determination and the surrounding free space computation may be performed as part of a unified candidate pair identification stage in which both criteria are evaluated together. In other examples, the Euclidean distance determination may be performed first to establish initial candidate connections (as illustrated at steps 608 and 612 of FIG. 6), followed by the free space computation as a secondary filter (as illustrated at steps 704 and 708 of FIG. 7) to remove connections that do not provide sufficient room for end effector insertion. Both approaches are within the scope of the present disclosure.

The collision-free connections identified through the foregoing process may be organized as a top-layer connection map, a graph-form data structure in which each node represents a detected object 116 on the surface of the pile in the pick bin 120 and each edge represents a candidate pair connection between two neighboring objects 116 that satisfy both the Euclidean distance threshold and the free space threshold. The top-layer connection map provides a structured representation of the accessible grasping opportunities available in the current pile configuration, and aids in the localization of objects 116 that are accessible for multi-object grasping. In this manner, the object grasping program 218 (see FIG. 2) can efficiently identify and rank candidate pairs for further evaluation of grasping pose and confidence, as further described with respect to FIGS. 7-10.

At 316 of the workflow 300, free space surrounding each candidate object pair is computed for potential finger insertion and contact surface selection. A detailed workflow for computing free space and contact surface selection is described with respect to FIG. 7. Computing a location for finger insertion relative to a selected object pair can include identifying the top and bottom surfaces of each object 116 in the pair based on the respective surface normals of the objects 116. In that regard, for a given object 116, the object grasping program 218 may compute the angle between the surface normal of the object 116 and the world z-axis. In some examples, the surface normals may be computed and the angular comparisons performed in a world coordinate frame, where the z-axis corresponds to the vertical axis (e.g., the direction opposing gravity). If the pose estimation is performed in a camera coordinate frame, a coordinate transformation from camera frame to world frame is applied prior to the surface normal comparison. Based on the angle, the system can determine whether a given surface of the object 116 is oriented upward or downward. For example, a small angle (e.g., below a threshold) can indicate that the surface of the object 116 is aligned closely with the z-axis, and that surface and its opposing surface can be considered by the system as the top and bottom surface, respectively. For objects 116 having a non-flat top or bottom (e.g., a pyramid), the surface having the smallest angular difference between its normal and the world z-axis is identified as the top surface, and the surface most opposite to it is identified as the bottom surface. In some examples, the identified top and bottom surfaces of each object 116 may be excluded as potential contact points for the end effector 110. In this manner, instability in grasping the objects 116 can be avoided.

A remaining side surface of each object 116 in the candidate pair may be selected for potential end effector contact, responsive to discarding the top and bottom surfaces as potential contact points. The free space surrounding each candidate contact surface represents an unobstructed volume, a three-dimensional region free of adjacent objects 116 or other obstacles, through which the end effector finger 112 may be inserted to achieve the desired grasping pose. A larger unobstructed volume around a contact surface indicates greater clearance for finger insertion and reduces the risk of collision with adjacent objects 116 during the grasping motion. The side surface for end effector contact may be selected based on the amount of unobstructed volume surrounding each candidate side surface, as further illustrated in FIG. 7. For example, a potential contact surface may be discarded responsive to the surrounding free space being smaller than a known circumference of the end effector finger 112. In some examples, a minimum grasp confidence threshold may be applied such that any candidate pair and grasping pose having a confidence below the threshold is discarded as a viable candidate. If all candidate pairs and associated grasping poses fall below the minimum confidence threshold, the system may determine that no viable candidate pair exists and may initiate the single-object fallback described herein.

At 320 of the workflow 300, a finger insertion location is selected based on the selected contact surface of the candidate pair, as further illustrated in FIG. 7. The finger insertion location defines the point at which one or more fingers 112 of the end effector 110 will be positioned relative to the candidate pair when the grasping pose is executed. In some examples, a selected finger 112 designated as a thumb may be positioned at or proximate to the selected contact surface, such that the thumb applies a stabilizing force against the contact surfaces of the pair while other fingers 112 engage the opposite side of one or both objects 116. The finger insertion location may be selected to maximize the available unobstructed volume for finger approach while minimizing the risk of collision with adjacent objects 116 in the pile. The finger insertion location contributes to the determination of candidate grasping poses in the subsequent step 324.

At 324 of the workflow 300, candidate grasping poses are identified for grasping the object pair. Examples of grasping poses are shown in FIGS. 8A-8E. In some examples, a set of stored grasping poses (also referred to herein as hand poses, where the end effector 110 is a robotic hand) are referenced as a basis for determining the grasping pose for an object pair. The system may determine one or more collision-free candidate grasping poses based on the unobstructed volume surrounding the object pair, the position and/or orientation of the objects 116 in the pair, the selected contact surface or surfaces of the object pair, or a combination thereof, as further illustrated in the hand pose fitting shown in FIG. 9.

At 328 of the workflow 300, a grasping pose is selected based on confidence levels associated with the candidate grasping poses. A detailed workflow for determining the confidence level of the grasping poses is described with respect to FIG. 10. For example, the candidate grasping poses may be input to a grasp confidence model to estimate the likelihood of grasp success for the object pair using each candidate pose. In some examples, the grasp confidence model is a suitable grasp quality estimation model, such as a grasp quality convolutional neural network (GQ-CNN), a reinforcement learning-based grasp evaluator, a physics-based grasp stability estimator, or another trained machine learning model that outputs a likelihood of grasp success. In some examples, the grasp confidence model is a DexNet model or another pre-trained grasp quality model fine-tuned for the specific end effector 110. The confidence estimator may be calibrated to the robotic device 102 and end effector 110. In some examples, the grasp confidence estimator outputs a confidence score in the range [0,1], where a score closer to 1 indicates a higher likelihood of a successful grasp.

In some examples, the grasp confidence estimator may be adapted to the specific end effector 110 in use. One way this may be accomplished is by fine-tuning a base confidence model using grasp success and failure data collected with the specific end effector 110, for example, by recording the outcomes of a series of grasp attempts on representative objects 116 under controlled conditions and using the resulting data to adjust the model's parameters. Another approach may involve applying post-processing adjustments based on known geometric or performance characteristics of the end effector 110. The adapted model parameters may be stored as calibration parameters 224 (see FIG. 2) in the memory 210 or system disk 212 of the robotic device 102 for use during operation. In some examples, the confidence estimator may be further adapted to the type, shape, or material of the objects 116 to be grasped. The particular approach used to adapt the confidence estimator to the end effector 110 is not critical to the claimed invention, and any suitable approach may be used.

In some examples, the approach angle and orientation for the grasping action may be determined based on the selected grasping pose. Because the grasping pose is selected based on grasping confidence, the corresponding approach angle and orientation are therefore associated with the highest-confidence grasping configuration. In this manner, the approach angle and orientation may correspond to the selected grasping pose based on grasping confidence. The approach angle and orientation may define the trajectory of the end effector 110 from its current position to the selected grasping pose in a manner that reduces the risk of collision with objects 116 in the pile and avoids disturbing the selected pair of objects 116 prior to grasping. In some examples, the approach angle and orientation may be computed based on the 6D pose of the selected pair and the geometry of the end effector 110, and may be further constrained by the calibration parameters 224 associated with the end effector 110 (see FIG. 2).

At 332 of the workflow 300, the pair of objects 116 may be grasped and lifted by the end effector 110 using the grasping pose selected based on the computed confidence level. For example, a collision-free grasping pose having the highest confidence level may be selected for grasping the pair of objects 116, as further described with respect to FIG. 10.

In some examples, the system may be configured to fall back to single-object grasping when no viable candidate pair is identified. For example, if no candidate pair satisfies the applicable thresholds or confidence criteria, the processor 202 may determine that no viable candidate pair is available among the detected objects 116 and may, in response, select a single object 116 and execute a single-object grasping action. Various single-object grasp planning approaches may be used in this context, including, for example, pose-based strategies or confidence-based selection applied to the single object 116 rather than to a pair. In some examples, implementing this fallback behavior may allow the system to maintain a high availability rate by ensuring that at least one grasp is executed per cycle even when multi-object grasping is not feasible, with the multi-object grasping pipeline resumed for subsequent cycles.

FIG. 4 illustrates an example workflow 400 for performing object detection and segmentation of objects 116 in the pick bin 120 of FIG. 1, according to the present teachings. Operations of the workflow 400 may be performed as part of, for example, step 304 of the workflow 300 of FIG. 3. The workflow 400 may be performed using the components described above with respect to FIGS. 1 and 2. For example, the processor 202 may execute the object grasping program 218 to perform one or more operations of the workflow 400 in conjunction with other components of the robotic system 100, such as the image sensor 104, motors 108, end effector 110, and/or the like.

At 404 of the workflow 400, image data 222 of the object pile in the pick bin 120 (see FIG. 1) is captured using the image sensor 104 (see FIGS. 1 and 2). For example, the image sensor 104 may capture the image of the object pile and output the image data 222 to the processor 202 for object detection and segmentation processing.

At 408 of the workflow 400, segmentation of the image data 222 is performed to separate the objects 116 from the background content of the image data 222. Background content may include the pick bin 120 or other surface on which the object pile is disposed, as well as any other environmental elements captured in the image that are not objects of interest. In some examples, a segmentation model may be applied to the image data 222 to identify and remove background pixels, producing a version of the image data 222 in which only the objects 116 are represented. Removing background content at this stage may reduce computational load for the individual object segmentation and pose estimation steps that follow.

At 412 of the workflow 400, instance segmentation of the image data 222 is performed to separate each individual object 116 from the others in the pile. Because the objects 116 may be arranged in a pile in which objects partially overlap or occlude one another, instance segmentation may involve identifying the precise boundaries of each individual object 116 even where portions of that object are obscured. In some examples, an instance segmentation model, such as a YOLO segmentation model, Segment Anything model (SAM), a Mask R-CNN, or another suitable model, may be applied to assign a distinct segmentation mask to each detected object 116. The resulting individual segmentation masks allow each object 116 to be treated independently in subsequent processing steps.

At 416 of the workflow 400, the individual detected objects 116 are identified and cropped for pose estimation, as further described with respect to FIG. 5.

FIG. 5 illustrates an example workflow 500 for performing pose estimation of individual detected and segmented objects 116, according to the present teachings. Operations of the workflow 500 may be performed as part of, for example, step 308 of the workflow 300 of FIG. 3, using the segmented and cropped objects 116 produced by the workflow 400 of FIG. 4. The workflow 500 may be performed using the components described above with respect to FIGS. 1 and 2. For example, the processor 202 may execute the object grasping program 218 and/or the object detection model 220 (see FIG. 2) to perform one or more operations of the workflow 500.

At 504 of the workflow 500, image data associated with each segmented and cropped object 116 (produced at step 416 of the workflow 400 of FIG. 4) may be received for pose estimation processing.

At 508 of the workflow 500, for each detected object 116, the segmented and cropped image of that object 116 may be shifted to the center of a modeling space for pose estimation. Centering the object 116 within the modeling space may allow the pose estimation model to evaluate the object's configuration in a normalized spatial context, which may improve the accuracy and consistency of the pose estimation output. The spatial offset applied to center the object 116 may be recorded so that the resulting pose estimation can be translated back to the object's original location in the image coordinate system at step 516.

At 512 of the workflow 500, for each object 116, the pose of that object 116 may be modeled using a suitable pose estimator, for example, a suitable pose estimation model (e.g., a YOLO-based pose estimator or another CNN-based or transformer-based pose estimation model), as stored in or accessible by the object detection model 220 (see FIG. 2).

At 516 of the workflow 500, an estimated 6D pose of the object 116, representing the spatial configuration of that object 116, may be generated and translated back to a coordinate system associated with the location of the object 116 in the original image data 222 (e.g., the image captured at step 304 of the workflow 300 of FIG. 3). For example, because each object 116 is shifted to the center of an image for pose modeling at step 508, the 6D pose data may be adjusted based on a translation of the object 116 from the center of the modeling space back to its original location and depth in the image data 222.

FIG. 6 illustrates an example workflow 600 for performing selection of object pairs based on connection distances, according to the present teachings. Operations of the workflow 600 may be performed as part of, for example, step 312 of the workflow 300 of FIG. 3. The workflow 600 may be performed using the components described above with respect to FIGS. 1 and 2. For example, the processor 202 may execute the object grasping program 218 to perform one or more operations of the workflow 600 in conjunction with other components of the robotic system 100, such as the image sensor 104, motors 108, end effector 110, and/or the like.

At 604 of the workflow 600, the captured image data 222 and the 6D poses of detected objects 116 (produced by the workflow 500 of FIG. 5) may be received for pair selection. In some examples, the captured image data 222 is pre-processed, for example, with the background removed as described with respect to step 408 of the workflow 400 of FIG. 4. In other examples, the captured image data 222 is original image data. In some examples, 6D pose data associated with detected objects 116 is embedded in the captured image data 222.

At 608 of the workflow 600, connection distances between neighboring objects 116 on the surface of the pile in the pick bin 120 (see FIG. 1) are computed. Each detected object 116 may be assigned a centroid based on its 6D pose estimate (as produced by the workflow 500 of FIG. 5), representing the object's approximate center position in the image or world coordinate frame. In some examples, the connection distance between two neighboring objects 116 is calculated as the Euclidean distance between their respective centroids. In other examples, the connection distance may be computed as the minimum separation distance between the bounding volumes or nearest surface points of the two objects 116. The computed connection distances are used in the subsequent step to identify which neighboring object pairs fall within grasping range of the end effector 110.

At 612 of the workflow 600, candidate pairs are selected based on the computed distances between neighboring objects 116. The candidate pairs may be selected based on the connection distance of an object 116 to a neighboring object 116 being less than a threshold distance associated with the grasp range of the end effector 110, as stored in the calibration parameters 224 of the robotic device 102 (see FIG. 2).

FIG. 7 illustrates an example workflow 700 for performing free space computation and contact surface selection for object pairs, according to the present teachings. Operations of the workflow 700 may be performed as part of, for example, steps 316 and/or 320 of the workflow 300 of FIG. 3. The workflow 700 may be performed using the components described above with respect to FIGS. 1 and 2. For example, the processor 202 may execute the object grasping program 218 to perform one or more operations of the workflow 700 in conjunction with other components of the robotic system 100, such as the image sensor 104, motors 108, end effector 110, and/or the like.

At 704 of the workflow 700, for each object 116 in a candidate pair (identified through the workflow 600 of FIG. 6), a top and/or bottom surface of the object 116 may be identified based on the angle between the surface normal of the object 116 and the world z-axis, as described herein. For each object 116, the surface having the smallest angular difference between the surface normal and the world z-axis may be identified as the top surface. The top surface and its opposing surface (e.g., the bottom surface) may be discarded as candidate contact surfaces for the end effector fingers 112.

At 708 of the workflow 700, the available unobstructed volume, that is, a three-dimensional region free of adjacent objects 116, for each candidate contact surface may be computed. For example, based at least in part on the 6D pose estimation of each object 116 (e.g., produced by the workflow 500 of FIG. 5), a mapping of the center of each object 116 in a candidate object pair and a mapping of each candidate contact surface in the candidate object pair may be determined. In some examples, this mapping is represented as a two-dimensional projection in the image plane or in a top-down projection of the pile, for example using a circular region centered on each candidate contact surface—as depicted in FIG. 7, where circular icons correspond to the amount of free space surrounding each candidate contact surface, and a larger radius indicates a greater amount of unobstructed free space for insertion of the end effector fingers 112. In other examples, the free space is represented as a three-dimensional unobstructed volume computed in the world coordinate frame, accounting for the height and depth of adjacent objects 116. The three-dimensional unobstructed volume representation may provide greater accuracy when objects 116 in the pile are at varying heights. In the context of the present disclosure, ‘unobstructed volume’ as recited in the claims refers to the available space surrounding a candidate contact surface that is free of adjacent objects 116 or other obstacles, and encompasses both two-dimensional representations of available free space in the image plane and three-dimensional volumetric representations computed in the world coordinate frame. In some examples, contact surfaces associated with an amount of unobstructed volume below a threshold may be discarded. The threshold amount of free space may correspond to a known size of the end effector fingers 112, as stored in the calibration parameters 224 (e.g., see FIG. 2). In some examples, an object pair is selected based on the amount of unobstructed volume available for its candidate contact surfaces.

FIGS. 8A-8E illustrate example grasping poses for grasping a pair of objects 116a-116b using the end effector 110, according to the present teachings. In the examples shown in FIGS. 8A-8E, the end effector 110 includes three fingers 112a-112c. In some examples, a selected finger, such as finger 112c, is designated as a thumb. The thumb 112c may be used for applying an opposing force to others of the fingers 112a and 112b, and is preferentially placed at the selected contact surface based on the surrounding unobstructed volume (e.g., as described herein with respect to FIG. 7). In some examples, such as the example of FIG. 8D, the grasping pose does not use all fingers 112 of the end effector 110 to grasp the object pair 116a-116b. While five poses are shown in the examples of FIGS. 8A-8E, additional grasping poses may be contemplated.

In some examples, some or all of the poses of FIGS. 8A-8E are selected as a basis for grasp determination. The set of stored grasping poses may be generated during a training and calibration phase. For example, during training, an object 116 may be grasped from a pile in the pick bin 120 using a particular grasping pose, the grasped objects 116 may be randomly dropped back into the pick bin 120, and the grasping pose may be adjusted to attempt to grasp the objects again. Each grasp attempt may be recorded as a success or failure. This process may be repeated iteratively to introduce small variations in the grasping approach and finger positions to capture a wide range of possible grasping pose configurations. The statistics associated with the training grasps can be used to identify the most effective grasping pose based on a current context and to allow for further refinement of the grasping strategy, contributing to the calibration parameters 224 stored in the system disk 212 (e.g., see FIG. 2).

FIG. 9 illustrates a fitting of candidate grasping poses to a model or image of the object pile in the pick bin 120 (e.g., see FIG. 1), according to the present teachings. Contact points of the end effector fingers 112 and thumb corresponding to different collision-free grasping poses may be mapped in a 3D space 904, as shown in FIG. 9. This mapping of candidate grasping poses may be fitted to corresponding candidate object pair locations in a model or image 908 of the object pile in the pick bin 120. The fitting shown in FIG. 9 may be performed as part of, for example, step 324 of the workflow 300 of FIG. 3. In some examples, the fitting of candidate grasping poses to candidate object pair locations may be performed iteratively. For example, an initial candidate grasping pose may be fitted to a candidate object pair based on the pair's 6D pose and selected contact surfaces, and the fit may then be refined in successive steps by adjusting one or more pose parameters, such as finger positions, approach angle, or end effector orientation, to improve the alignment of the pose with the specific spatial configuration of the pair. This iterative adjustment may continue until a set of geometrically feasible candidate poses has been identified for the candidate pair, or until a maximum number of iterations has been reached. In this manner, the pose fitting process may adapt to the dynamic configuration of the pile, accounting for variations in object height, orientation, and spacing that differ from pair to pair.

FIG. 10 illustrates an example workflow 1000 for determining grasp confidence associated with candidate grasping poses, according to the present teachings. Operations of the workflow 1000 may be performed as part of, for example, step 328 of the workflow 300 of FIG. 3. The workflow 1000 may be performed using the components described above with respect to FIGS. 1 and 2. For example, the processor 202 may execute the object grasping program 218 to perform one or more operations of the workflow 1000 in conjunction with other components of the robotic system 100, such as the image sensor 104, motors 108, end effector 110, and/or the like.

At 1004 of the workflow 1000, a fitting of candidate grasping poses to candidate object pairs (e.g., produced by the process of FIG. 9) may be received. For example, the processor 202 may determine one or more candidate grasping poses for each remaining candidate object pair.

At 1008 of the workflow 1000, a confidence of success for each potential grasp is determined. The confidence may be determined using a suitable confidence estimator calibrated to the robotic device 102 and end effector 110, as described herein. In some examples, the confidence estimator is further calibrated to the type of objects 116 to be grasped. In some examples, the confidence estimator is a pre-trained grasp quality model, such as a grasp quality convolutional neural network (e.g., GQ-CNN) or a similar model, optionally fine-tuned based on calibration data collected with the end effector 110. In some examples, the confidence estimator outputs a confidence score in the range [0,1], where a score closer to 1 indicates a higher likelihood of a successful grasp. In some examples, an object pair and associated grasping pose is selected based on the highest likelihood of success among the candidate object pairs and candidate grasping poses. For example, a grasping pose and corresponding object pair having a confidence of 0.86 may be selected over a grasping pose and corresponding object pair having a confidence of 0.79.

FIG. 11 illustrates an example process 1100 for performing multi-object grasping, according to the present teachings. The process 1100 may be performed using the components and/or techniques described above with respect to FIGS. 1-10. For example, the processor 202 may execute the object grasping program 218 to perform one or more operations of the process 1100 in conjunction with other components of the robotic system 100, such as the image sensor 104, motors 108, end effector 110, and/or the like. The process 1100 corresponds to the workflow 300 of FIG. 3 and the sub-workflows of FIGS. 4-10.

At 1104 of the process 1100, the process includes detecting, based on image data 222 received from the image sensor 104 (e.g., see FIGS. 1 and 2), a plurality of objects 116. For example, the processor 202 can detect a plurality of objects 116 in image data 222 captured by the image sensor 104 using techniques described above with respect to FIGS. 3-5. In that regard, the process 1100 can include performing object segmentation (e.g., as in the workflow 400 of FIG. 4) to separate background content of the image data 222 from the plurality of objects 116, and determining a spatial configuration of each object 116 of the plurality of objects using 6D pose estimation (e.g., as in the workflow 500 of FIG. 5). Each spatial configuration can be a 6D estimation having three pose dimensions and three rotation dimensions.

In some examples, the plurality of objects 116 is disposed on a non-uniform surface, such as the pick bin 120 of FIG. 1. For example, the plurality of objects 116 can form a top layer of an object pile in the pick bin 120.

At 1108 of the process 1100, the process includes identifying a plurality of candidate pairs of objects 116 from the plurality of objects. For example, the processor 202 can identify a plurality of candidate pairs of objects 116 using techniques described above with respect to FIGS. 3, 6, and 7. In that regard, the process 1100 may include determining Euclidean distances between neighboring objects 116 of the plurality of objects (e.g., as in the workflow 600 of FIG. 6) and amounts of surrounding unobstructed volume detected around neighboring objects 116 (e.g., as in the workflow 700 of FIG. 7). Candidate pairs having a Euclidean distance above a first threshold can be discarded as candidates, and candidate pairs having an amount of surrounding free space below a second threshold can be discarded as candidates.

At 1112 of the process 1100, the process includes identifying a respective grasping pose for each respective candidate pair based on a respective orientation of the respective candidate pair. For example, the processor 202 can identify a respective grasping pose for each respective candidate pair using techniques described above with respect to FIGS. 3, 7, 8A-8E, and 9. In that regard, the process 1100 can include: selecting a contact surface for an object 116 in the respective candidate pair based on an unobstructed volume between the contact surface and an adjacent object 116; and determining a finger insertion location (e.g., including, as a specific example, a thumb insertion location as described with respect to FIGS. 7 and 8A-8E) relative to the respective candidate pair based on the contact surface. In some examples, the process 1100 can include: computing a respective surface normal for each object 116 in the respective candidate pair; computing a respective angle between the respective surface normal and the surrounding environment z-axis; identifying a top surface and a bottom surface of each respective object 116 in the candidate pair based on the respective angle; and selecting the contact surface from a surface different from the top surface and the bottom surface of each respective object 116 in the candidate pair, as further described with respect to FIG. 7.

At 1116 of the process 1100, the process includes selecting a selected pair of objects 116 from the plurality of candidate pairs and a selected grasping pose for the selected pair based on grasping confidence. For example, the processor 202 can select a pair of objects 116 from the plurality of candidate pairs and select a selected grasping pose for the selected pair based on a grasping confidence computed using techniques described above with respect to FIGS. 3, 9, and 10.

At 1120 of the process 1100, the process includes executing a grasping action based on the selected grasping pose to grasp the selected pair of objects 116. For example, the processor 202 can control the robotic device 102 to execute the grasping action using techniques described above with respect to FIGS. 3 and 8A-8E. In that regard, the process 1100 can include determining an approach angle and orientation corresponding to the selected grasping pose, which was itself selected based on grasping confidence, and controlling a movement of the robotic arm 102 to the selected grasping pose via the approach angle and orientation. The process 1100 further includes controlling a movement of the end effector 110 to a destination location, such as a conveyor belt, container, or other target location to which the grasped objects 116 are to be transported.

The claims, and not the specific examples, embodiments, or other disclosures in this specification, define the protection sought by the applicant. The specific examples and embodiments described herein are illustrative only and are not intended to limit the scope of the claimed invention. In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as critical, required, or essential features or elements of any or all the claims.

Moreover, in this document, relational terms such as first and second, top and bottom, and the like may be used to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application-specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for a robotic arm, the system comprising:
a memory storing instructions; and
at least one processor electronically coupled with the memory, the robotic arm, and an image sensor, the at least one processor operable to execute the instructions to cause the system to:
detect, based on image data received from the image sensor, a plurality of objects;
identify a plurality of candidate pairs of objects from the plurality of objects;
identify a respective grasping pose for each respective candidate pair based on a respective orientation of the respective candidate pair;
select a selected pair of objects from the plurality of candidate pairs and a selected grasping pose for the selected pair based on grasping confidence; and
execute a grasping action based on the selected grasping pose to grasp the selected pair of objects.

2. The system of claim 1, wherein the plurality of candidate pairs are identified based on detected positions of the objects without repositioning any object prior to identifying the candidate pairs.

3. The system of claim 2, wherein the plurality of objects form a top layer of an object pile, and wherein the two objects of a candidate pair may be at different heights relative to one another within the pile.

4. The system of claim 1, wherein, to detect the plurality of objects, the instructions cause the system to:
perform object segmentation to separate background content of the image data from the plurality of objects; and
determine a spatial configuration of each object of the plurality of objects.

5. The system of claim 4, wherein each spatial configuration is a 6-dimensional (6D) estimation having three pose dimensions and three rotation dimensions.

6. The system of claim 1, wherein, to identify the plurality of candidate pairs, the instructions cause the system to:
determine distances between neighboring objects of the plurality of objects and amounts of surrounding free space detected around neighboring objects of the plurality of objects.

7. The system of claim 6, wherein candidate pairs having a distance above a first threshold are discarded as candidates, and candidate pairs having an amount of surrounding free space below a second threshold are discarded as candidates.

8. The system of claim 1, wherein, to identify a respective grasping pose, the instructions cause the system to:
select a contact surface for an object in the respective candidate pair based on an unobstructed volume between the contact surface and an adjacent object; and
determine a finger insertion location relative to the respective candidate pair based on the contact surface.

9. The system of claim 8, wherein, to identify a respective grasping pose, the instructions cause the system to:
compute a respective surface normal for each object in the respective candidate pair;
compute a respective angle between the respective surface normal and a surrounding environment z-axis;
identify a top surface and a bottom surface of each respective object in the respective candidate pair based on the respective angle; and
select the contact surface from a surface different from the top surface and the bottom surface of each respective object in the respective candidate pair.

10. The system of claim 1, wherein the instructions further cause the system to:
select an approach angle and orientation for reaching the selected grasping pose based on the grasping confidence; and
control a movement of the robotic arm to the selected grasping pose via the approach angle and orientation.

11. The system of claim 1, wherein the grasping confidence is determined by a grasp confidence estimator comprising a trained machine learning model calibrated to an end effector of the robotic arm.

12. The system of claim 1, wherein the instructions further cause the system to:
determine whether a viable candidate pair exists among the plurality of candidate pairs; and
in response to determining that no viable candidate pair exists, select a single object from the plurality of objects and execute a single-object grasping action to grasp the selected single object.

13. A process for controlling a robotic arm, the process comprising, at a processor operably coupled to the robotic arm and an image sensor:
detecting, based on image data received from the image sensor, a plurality of objects arranged in a pile;
identifying a plurality of candidate pairs of objects from the plurality of objects;
for each respective candidate pair, identifying a respective grasping pose for an end effector of the robotic arm to grasp the respective candidate pair based on a respective orientation of the respective candidate pair;
selecting a selected pair of objects from the plurality of candidate pairs and a selected grasping pose for the selected pair based on grasping confidence;
executing a grasping action with the end effector based on the selected grasping pose to grasp the selected pair of objects; and
controlling a movement of the end effector to a destination location.

14. The process of claim 13, wherein detecting the plurality of objects includes:
performing object segmentation on the image data to separate background content of the image data from the plurality of objects; and
determining a spatial configuration of each object of the plurality of objects.

15. The process of claim 13, wherein identifying the plurality of candidate pairs includes:
determining distances between neighboring objects of the plurality of objects and amounts of surrounding free space detected around neighboring objects of the plurality of objects.

16. The process of claim 15, wherein candidate pairs having a distance above a first threshold are discarded as candidates, and candidate pairs having an amount of surrounding free space below a second threshold are discarded as candidates.

17. The process of claim 13, wherein identifying a respective grasping pose includes:
selecting a contact surface for an object in the pair of the objects based on an unobstructed volume between the contact surface and an adjacent object; and
determining a finger insertion location relative to the respective candidate pair based on the contact surface.

18. The process of claim 17, wherein identifying a respective grasping pose further includes:
computing a respective surface normal for each object in the candidate pair;
computing a respective angle between the respective surface normal and a surrounding environment z-axis;
identifying a top surface and a bottom surface of each respective object in the candidate pair based on the respective angle; and
selecting the contact surface from a surface different from the top surface and the bottom surface of each respective object in the candidate pair.

19. A non-transitory computer readable medium storing instructions that, when executed by a processor, cause the processor to:
detect, based on image data received from an image sensor, a plurality of objects;
identify a plurality of candidate pairs of objects from the plurality of objects;
identify a respective grasping pose for each respective candidate pair based on a respective orientation of the respective candidate pair;
select a selected pair of objects from the plurality of candidate pairs and a selected grasping pose for the selected pair based on grasping confidence; and
control a robotic arm to execute a grasping action based on the selected grasping pose to grasp the selected pair of objects.

20. The non-transitory computer readable medium of claim 19, wherein, to identify the plurality of candidate pairs, the instructions cause the processor to:
determine distances between neighboring objects of the plurality of objects and amounts of surrounding free space detected around neighboring objects of the plurality of objects.
